(19) United States
(12) Patent Application Publication
(10) Pub. No.: US 2024/0070713 A1
(43) Pub. Date: Feb. 29, 2024

(54) METHOD AND APPARATUS TO PROVIDE REPLACEABLE GRAPHICAL REPRESENTATION ON A HOME SCREEN

(71) Applicant: IRON GAMING LIMITED, St. Julians (MT)

(72) Inventors: Peter Marek Zmijewski, Singapore (SG); Scott Dowdell, Singapore (SG)

(73) Assignee: IRON GAMING LIMITED, St. Julians (MT)

(21) Appl. No.: 18/235,763

(22) Filed: Aug. 18, 2023

(30) Foreign Application Priority Data
Aug. 23, 2022 (SG) 10202250808Q

(51) Int. Cl. G06Q 30/0241; G06F 3/04817; G06F 3/04842; G06F 9/455; G06F 16/95

(52) U.S. Cl. CPC G06Q 30/0241; G06F 3/04817; G06F 3/04842; G06F 9/455; G06F 16/95

(57) ABSTRACT

A method and an apparatus to provide replaceable graphical representation on a home screen of an apparatus, the method comprising: executing, via a processor, an application in a memory during start up of the apparatus to operate the apparatus to: display one or more graphical representations on a home screen of the apparatus without preventing accessibility to at least one feature of the home screen that is not displayed by the application in the home screen; and replace the one or more graphical representations displayed on the home screen, wherein each of the one or more displayed graphical representations is replaced when a predetermined condition is satisfied, wherein at least one of the one or more graphical representations is an advertisement selectable by a user to perform one or more actions.

### CROSS-REFERENCE TO RELATED APPLICATIONS

This application claims priority to Singapore Application No. 10202250808Q filed in Singapore on Aug. 23, 2022, which is hereby incorporated herein by reference.

### FIELD

The field relates to a method and an apparatus to provide replaceable graphical representation on a home screen of an apparatus. The graphical representation is configured to be replaced based on a predetermined condition. The graphical representation may be an advertisement in the form of an icon, a banner, or a video, which is selectable to perform one or more actions.

### BACKGROUND

Computer users typically have several icons on the home screen of their computers. These icons are shortcuts serving only one purpose to open files or computer programs when they are clicked on. These programs are installed by users or available with the operating system (OS) of the users' computer. The files are created or saved by users onto the home screen.

### SUMMARY

According to an example of the present disclosure, there are provided a method and an apparatus as claimed in the independent claims. Some optional features are defined in the dependent claims.

### BRIEF DESCRIPTION OF THE DRAWINGS

Examples in the present disclosure will be better understood and readily apparent to one skilled in the art from the following written description, by way of example only and in conjunction with the drawings, in which:

FIG. 1 shows a flowchart describing a workflow according to an example of the present disclosure.

FIG. 2 shows graphical representations displayed in a home screen according to an example of the present disclosure.

FIG. 3 shows launching an application executable by an emulator through a graphical representation configured according to an example of the present disclosure.

FIG. 4 shows a system architecture for launching the application executable by the emulator illustrated in FIG. 3.

FIG. 5 shows a flowchart illustrating the installation of the emulator illustrated in FIG. 3, and launching of the application executable by the emulator.

FIG. 6 shows one mode of displaying the graphical representations in a home screen according to an example of the present disclosure, which involves a search function.

FIG. 7 shows one mode of displaying just one graphical representation in a taskbar of a home screen according to an example of the present disclosure.

FIG. 8 shows a user interactive graphical representation displayed in a home screen according to an example of the present disclosure, which comprises other graphical representations.

### DETAILED DESCRIPTION

An example of a method and an apparatus of the present disclosure is capable of providing one or more replaceable graphical representations on a home screen (also known as start up screen, menu screen, desktop screen, or main screen), without preventing accessibility to one or more pre-existing displayed features associated with the home screen. Each graphical representation can function as an advertisement and replacing the graphical representations periodically would transform the conventional home screen into a personal digital billboard. A digital billboard refers to a billboard primarily used for advertising that displays digital images changed by a computer periodically (typically every few seconds).

In the present example, the apparatus is a desktop computer, a tablet computer, a laptop computer (or notebook), or the like. The operating system of the apparatus can be Windows Operating System, Mac OS (a Unix based operating system used on Apple Mac computers), Linux, Android, or the like.

In apparatuses having a home screen, the home screen is typically displayed after the apparatus starts up in a display (e.g. a monitor made based on technologies such as LCD, LED, OLED, CRT, and the like, with or without touch screen feature) that is connected to the apparatus. The home screen typically displays a plurality of icons that are selectable or clickable by a user via a user input device (e.g. a mouse, touch input on a touch screen, keyboard, keypad etc.) to activate programs (or applications) and/or internal functions of the apparatus. On an apparatus with Windows Operating System or Mac OS, the home screen can be called the desktop home screen. In the present disclosure, the examples provided are based on the Windows Operating System. However, it should be appreciated that a skilled person will be able to adapt from the same concepts and implement similar features on other Operating Systems.

At least one of the one or more replaceable graphical representations should be displayed in a manner such that it will not interfere with user access to one or more features associated with the home screen such as pre-existing icons, start button or other buttons, taskbar, etc. The one or more features is not affected when the at least one graphical representation is displayed together with them on the same home screen. A user still have access to these one or more features i.e. the user can still select the pre-existing icons to activate programs, the user can still use the taskbar on the home screen, etc. The objective of such at least one graphical representation is to not interfere or have minimum interference with the features associated with the home screen. However, it is possible to have one or more of the replaceable graphical representations that will temporarily interfere or disrupt the accessibility of the one or more features associated with the home screen. For example, one or more of the graphical representation may be configured to displayed in full screen temporarily upon the start up of the apparatus but disappear or change into a smaller graphical representation after the temporary full screen display. During the full screen display, none of the one or more features associated with the home screen may be accessible. After the at least one graphical representation not interfering with the one or more features associated with the home screen is displayed, the at least one graphical representation may be selected by a user to take actions that can interfere with the displayed features associated with the home screen, for example, displaying a video that takes up full screen, displaying a window that takes up full screen, or displaying graphics of an application that takes up full screen.

In one example of the present disclosure, the apparatus comprises a processor or processing unit configured to execute an application or program stored in a memory. The application is programmed to be executed during start up of the apparatus before the home screen is displayed. Upon execution, the application causes a plurality of graphical representations to be displayed on the home screen of the apparatus. The plurality of graphical representations may include an icon, a folder or item providing access to one or more of the plurality of graphical representation, an image, a wallpaper, and/or a video. The image may be a banner, which shows an advertisement comprising a promotion, recommendation, notice, and/or alert.

In this example, the application is configured to display the plurality of graphical representations along with a plurality of icons and taskbar already existing on the home screen upon the start up of the apparatus. One or more of the plurality of graphical representations may be provided in the foreground but is configured to not cover the existing icons as much as possible until the one or more graphical representations is being moved over the existing icons. One or more of the plurality of graphical representations may be provided in the background with one or more of the existing icons in the home screen in the foreground. In this case, one or more of the plurality graphical representations covered by the existing icons may become accessible after moving away the existing icons to another location of the home screen. The pre-existing displayed features associated with the home screen such as icons, start button or other buttons, taskbar etc. are not displayed by the application. The application is only capable of displaying and controlling graphical representations it is configured to display. In the present disclosure, the abovementioned image may have any size and can be a photograph. The wallpaper can also an image, which can be a photograph or image file, but it generally stays longer on the home screen compared to a banner. A banner generally stays on the home screen for a shorter time duration compared to the wallpaper.

Each of the plurality of graphical representations may be an advertisement comprising a promotion, recommendation, notice, and/or alert. One or more of the plurality of graphical representations may be configured to be selectable or clickable by a user to trigger one or more actions, or may be configured to provide access to one or more further graphical representations that are selectable by a user to trigger one or more actions. The user selection to trigger the one or more actions can be performed by clicking the graphical representation and/or hovering over the graphical representation (i.e. hover over without actually clicking). Optionally, one or more of the plurality of graphical representations may be configured to have no action upon being selected or clicked by a user and serve just as a decoration (e.g. wallpaper) or notice.

One of the plurality of graphical representations should be one or more of the following:
1) a link to open one or more web pages, and the action triggered after selection is to open the one or more webpages;
2) a shortcut to execute or run one or more applications, and the action triggered after selection is to execute the one or more applications, wherein the one or more applications to be executed can include a .exe or .dmg file;
3) a link to download and/or install one or more applications onto the apparatus;
4) a link to download one or more files;
5) a link to add an item to a cart (e.g. shopping cart for online purchases);
6) a link to activate an Internet browser to take certain actions (e.g. open web page in the browser, open a window containing graphical contents of an application to be displayed, extract or retrieve item from web page, access item on a web page, etc.);
7) a link to show a video, a message, a notice, or show an image (e.g. static, animated or slide show) after user selection (e.g. a user may click on the graphical representation or hover over the graphical representation to show the video, message, notice or image); and/or
8) an item (e.g. a folder) selectable to display one or more of the graphical representations described above.

In one example, one or more of the plurality of graphical representations can be a shortcut to run a game application if it is installed on the apparatus, or to download and install the game application.

The application is configured to obtain the content of each of the plurality of graphical representations from an apparatus external to the apparatus executing the application. For example, the external apparatus may be one or more servers or one or more databases accessible via the Internet, and the one or more servers or one or more databases may be cloud based. The content may include an icon image, a banner image, a video file, a wallpaper image, and/or a web address containing an embedded video and/or image. The icon image, the video, the banner image, and/or the wallpaper image may be shortcuts to open one or more web pages, and in this case, the one or more web addresses of the one or more web pages will be part of the content. The external apparatus may be configured to push different graphical representations to the application for displaying periodically.

Preferably, the application should be configured to request for the content of each of the plurality of graphical representations from the external apparatus during the start up of the apparatus. This notifies the external apparatus that the application is activated for displaying replaceable graphical representations.

Each of the plurality of graphical representations are configured to change according to a predetermined condition. For example, each graphical representation may be displayed for a predetermined time duration and replaced by another graphical representation when the time duration expires. A graphical representation displayed previously can be rotated to be displayed again. Such periodic replacement is required to provide the function of a personal digital billboard. For example, the application may be configured to use an algorithm to control which graphical representation to be replaced and which graphical representation is to be displayed at any time instance.

For example, each of the plurality of graphical representations can be configured to be changed or replaced as follows:
(a) daily, hourly, weekly, monthly, annually, fortnightly, or according to a predetermined time duration; and/or
(b) when the application receives instruction (e.g. from an external server) to replace the graphical representation; and/or
(c) (i) after being selected or clicked, or
   (ii) after being selected or clicked and the application is instructed (e.g. by an external server) to replace the graphical representation.

An example for (c)(ii) above is that after a graphical representation is selected or clicked, a web page hosted by a server opens to prompt a user to download an application, buy a product or sign up for a particular service. If the user completes the downloading, the purchase, or signing up, a feedback from the server can be sent to application to instruct the application not to show the graphical representation on the home screen again.

The content of each of the plurality of graphical representation obtained from the external apparatus by the application can include the predetermined conditions determining how the plurality of graphical representation is to be replaced.

After one or more graphical representations are displayed by the application, the application may periodically contact the external apparatus to obtain instruction or update. The instructions or updates may include to continue to display one or more graphical representations currently being displayed, to display one or more graphical representations in addition to one or more graphical representations currently being displayed, to add one or more graphical representations to be rotated with other graphical representations for displaying at a specific location in the home screen, or to replace one or more of the graphical representations currently being displayed. Alternatively, the external apparatus may be configured to periodically instruct or update the application to continue to display one or more graphical representations currently being displayed, to display one or more graphical representations in addition to one or more graphical representations currently being displayed, to add one or more graphical representations to be rotated with other graphical representations for displaying at a specific location in the home screen, or to replace one or more of the graphical representations currently being displayed. A secure communication channel may be established before the application can communicate with the external apparatus.

In the case of an icon to be displayed by the application on the home screen, it may have a size typical of a shortcut icon that appears on a desktop home screen (e.g. 48 pixels by 48 pixels), or having a size according to size settings provided in the content obtained from the external apparatus. Each icon can be a logo or trademark associated with an organization selling items and/or providing services. The application may be configured to enable creation of folders to contain a plurality of icons and/or grouping of icons. For example, an icon may be dragged and dropped over another icon to create a new folder containing these two icons, an icon may be dragged and dropped over an existing folder to be placed into the folder, a folder may be created and icons may be copied or cut and placed into the created folder etc. Each icon displayed by the application can be configured to be in the foreground and cover pre-existing displayed features associated with the home screen (e.g. pre-existing icons, start button or other buttons, taskbar etc.), or in the background and not covering the pre-existing displayed features associated with the home. The icon should be displayed at a location least probable for the pre-existing displayed features associated with the home screen to be present. For example, in the desktop screen of a Windows Operating System or MacOS, the taskbar is typically at the bottom of the screen and the pre-existing icons are typically located on the left side of the screen. Hence, the icon to be displayed should appear above the bottom of the screen at a location not interfering with the taskbar and at the center of the screen or on the right side of the screen so as not to interfere with the pre-existing icons typically on the left side of the screen.

In the case of a banner or wallpaper to be displayed by the application on the home screen, it may have a size set according to size settings provided in the content obtained from the external apparatus. The wallpaper should generally be sized to fill the home screen substantially (e.g. fill entirely or close to filling the entire home screen). However, it is also possible to set its size to fill the home screen partially (e.g. about 75%). The wallpaper should be configured to reside in the background of the home screen upon start up of the apparatus, and not interfere with pre-existing displayed features associated with the home screen (e.g. pre-existing icons, start button or other buttons, taskbar etc.) until the wallpaper is activated to enable one or more graphical representations to selected by a user. A banner can also fill up the home screen but generally, it is expected to take up lesser space on the home screen compared to a wallpaper image. The banner displayed by the application should preferably be configured to be in the foreground and cover pre-existing displayed features associated with the home screen (e.g. pre-existing icons, start button or other buttons, taskbar etc.). It is possible but less preferred to display the banner in the background and not covering pre-existing displayed features associated with the home screen. The banner should be displayed at a location least probable for the pre-existing displayed features associated with the home screen to be present. For example, in the desktop screen of a Windows Operating System or MacOS, the taskbar is typically at the bottom of the screen and the pre-existing icons are typically located on the left side of the screen. Hence, the banner to be displayed should appear above the bottom of the screen at a location not interfering with the taskbar and at the center of the screen or on the right side of the screen so as not to interfere with the pre-existing icons typically on the left side of the screen.

The icon image, the banner image and/or the wallpaper image may be static images (e.g. in file formats, ICO, JPEG, PNG, TIFF, and the like), or animated images including a slideshow showing a sequential display of images (e.g. in file formats, GIF, SVG and the like).

For example, there can be one or more Uniform Resource Locators (URL) linked to the icon image, banner image, or wallpaper image. When the icon image, banner image, or wallpaper image is selected by a user on the home screen, one or more web pages corresponding to the URLs are opened. In another example, the icon image, banner image or wallpaper image displayed by the application may be a shortcut selectable to download a file, download and install an application not installed on the apparatus, add item to a web cart or store, and/or run an application already installed on the apparatus, for instance, an emulator.

The emulator may be configured to run or execute an application (e.g. a mobile application) on the apparatus, which is not natively configured to run such application. The graphical representation may be a shortcut to an application executable by the emulator simulating an operating system capable of executing the application. Selecting the graphical representation will run the emulator and the emulator may be configured to automatically run the application if it is installed. After the emulator is run, it can check whether the application is installed or not. Alternatively, instead of the emulator, the application providing replaceable graphical representation may check whether the application is installed or not. The emulator can be configured to download and install the application if the check shows that the application is not installed. After downloading and installation, the emulator automatically runs the application. In one example, the application providing replaceable graphical representation may instruct the emulator to run the application.

The application providing replaceable graphical representation according to the examples of the present disclosure can be a standalone application or can be a feature or part of another application such as the emulator as described. For example, the application providing replaceable graphical representation can be the emulator itself.

In one example, the emulator as described above may simulate a Mobile Device Operating System (e.g. Android) to run a mobile application on an apparatus having, for instance, Windows Operating System or Mac OS, which are not natively configured to run the mobile application. In this case, one of the graphical representations displayed on the home screen may be a mobile application icon associated with the mobile application (e.g. apk, ipa etc.) executable by the emulator. The mobile application icon is selectable to execute the emulator if the emulator is installed. If the emulator is not installed, a downloading and installation process of the emulator begins, and the emulator is executed after it is downloaded and installed. Once the emulator is executed, the emulator receives data of the mobile application from the application providing replaceable graphical representations. Thereafter, the emulator facilitates the downloading and installation of the mobile application. While facilitating, for example, the emulator may simply download the mobile application from a server, or may prompt a user to login to an application store (e.g. Google Play Store, Amazon Play Store etc.) in order to download a mobile application. The emulator can be configured to execute the mobile application after the mobile application is downloaded and installed. The mobile application can be executed immediately by the emulator after it is installed so that the process from selecting the graphical representation to executing the mobile application would appear to be seamless. The emulator may be configured to instruct the application providing the graphical representations to replace the mobile application icon with another graphical representation (e.g. another mobile application icon), or to update a server and this server will instruct the application providing the graphical representations to replace the mobile application icon with another graphical representation (e.g. another mobile application icon).

In the case of a video to be displayed by the application on the home screen, it can be sized by the application according to settings provided with the video in the content obtained from the external apparatus. The video may be a video playable on a web page and the application is configured to display a window linked to the web page to play the video. In another example, the video may be automatically downloaded to the apparatus by the application and the application is configured to play the video file when the home screen is displayed. The video may be configured to be a shortcut selectable to open one or more web pages, download a file, add item to a web cart or store, download and install an application not installed on the apparatus, and/or run an application already installed on the apparatus, for instance, the abovementioned emulator. The video may be in file formats, MP4, MOV, WMV, AVI, AVCHD, FLV, F4V, SWF, MKV, WEBM (or HTML5) and the like. The video displayed by the application should preferably be configured to be in the foreground and cover pre-existing displayed features associated with the home screen (e.g. pre-existing icons, start button or other buttons, taskbar etc.). It is possible but less preferred to display the video in the background and not covering the pre-existing displayed features associated with the home screen. The video should be displayed at a location least probable for the pre-existing displayed features associated with the home screen to be present. For example, in the desktop screen of a Windows Operating System or MacOS, the taskbar is typically at the bottom of the screen and the pre-existing icons are typically located on the left side of the screen. Hence, the video to be displayed should appear above the bottom of the screen at a location not interfering with the taskbar and at the center of the screen or on the right side of the screen so as not to interfere with the pre-existing icons typically on the left side of the screen.

In one example, an image, banner or wallpaper to be displayed by the application on the home screen may be a static image comprising one or more selectable graphical representations in it. Each of these selectable graphical representations may be a shortcut selectable to open one or more web pages, download a file, add item to a web cart or store, download and install an application not installed on the apparatus, and/or run an application already installed on the apparatus, for instance, the abovementioned emulator.

In another example, the graphical representation may be configured to be interactive, which means that it allows a user to interact with it. For example, it can be in the form of an interactive image (which includes a banner), or wallpaper configured to display, for instance, a virtual place such as a virtual shop, virtual world, or the like. A user can activate the image or interactive wallpaper by selecting it, or activate it via a certain trigger (e.g. press a specific keyboard button, select an item on the image or wallpaper, etc.). Upon activation, the user can navigate and move around in the virtual place (e.g. use arrow keys on a keyboard to move). The virtual place can be configured to display a plurality of selectable graphical representations located at different locations in the virtual place. The user can move to different locations in the virtual place to select the graphical representations of his or her choice. Each of the selectable graphical representations can be a shortcut selectable to open one or more web pages, download a file, add item to a web cart or store, download and install an application not installed on the apparatus, and/or run an application already installed on the apparatus, for instance, the abovementioned emulator. Existing icons on the home screen not displayed by the application of the examples of the present disclosure can lay over (i.e. appear in the foreground) the interactive image or wallpaper and the interactive image or wallpaper is displayed in the background. In one example, upon activation, the interactive image or wallpaper may move from the background into the foreground and the existing icons on the home screen are covered up. In this case, the existing icons will not interfere with the use of the interactive image or wallpaper.

For example, the virtual place displayed on the home screen may be a virtual shop of a seller of a plurality of products. The plurality of products are displayed in the virtual shop, wherein each product being sold has a graphical representation in the virtual shop, which is selectable to add to a cart for purchasing the product. The virtual place may also be an application store selling or distributing a plurality of applications. The plurality of applications are displayed in the virtual place, wherein each application being sold or advertised has a graphical representation in the virtual place, which is selectable to purchase and/or to download the application.

Examples of the content of the graphical representations obtained by the application to provide replaceable graphical representations are as follows. For instance, the content of an icon or banner may include an icon or banner image, a time duration it is to be displayed including start time of display and end time of display, instructions upon selection of the icon or banner such as details of a web page to be opened upon the selection etc. For instance, the content of a video may include display size of the video on the display, a time duration it is to be displayed including start time of display and end time of display, details of a web page to be opened to stream the video, instructions upon selection of the video such as details of a web page to be opened upon the selection etc. For instance, the content of a wallpaper may include, display size of the wallpaper on the display, a time duration the wallpaper is to be displayed including start time of display and end time of display, a plurality of icon images to be displayed in the wallpaper, a time duration each icon is to be displayed including start time of display and end time of display, instructions upon selection of each icons such as details of a web page to be opened upon the selection etc. The wallpaper may be configured to be displayed until a user decides to change it but each graphical representation displayed in the wallpaper are changed according to the time duration associated with it.

The application providing replaceable graphical representation can be configured such that it is adjustable via its settings to disable interactive features of a graphical representation and/or disable the ability to select the one or more graphical representations displayed. For example, once disabled, a wallpaper will become a conventional wallpaper, a banner or a video will show an advertisement and clicking it has no effect, etc. The periodic replacement of the graphical representations should still exist to provide the function of a personal digital billboard.

In one example, the graphical representations may be categorised. For example, the categories of the graphical representations can include:
shopping
Entertainment (including gaming; In another example, gaming can be a category on its own)
travel
education
technology
cryptocurrency
news
utility (i.e. tools such as camera function, calculator, etc.)
social media
etc.

The application providing replaceable graphical representation may be configured to display only one graphical representation per category on the home screen, and the number of categories can be adjustable or fixed. For example, the application may be configured to only display 4 icons by default and each icon is associated with one category. A user may adjust the settings of the application to display more or lesser icons in the same or different categories. In this example, the 4 categories corresponding to the 4 respective icons that are provided as a default may be shopping, travel, entertainment, and news. Clicking each icon would open a web page related to the category. For example, a shopping icon with a logo of an e-commerce merchant can be clicked to open a web page hosted by a server of the e-commerce merchant. This shopping icon may be replaced by another shopping icon with a logo of another e-commerce merchant daily or another limited time duration as programmed. This shopping icon may also be changed to another shopping icon after the user clicks on it, or after the user performs certain actions on the web page linked to the clicked shopping icon and as a result of the actions, a server instructs the application to replace the shopping icon with another one.

In another example, in the case that an icon, banner, wallpaper, or video is an advertisement of a mobile application playable by an emulator, a feedback can be sent to the application (that provides replaceable graphical representations) if the advertisement is selected, the emulator is installed, a user account for mobile application usage is created, and the mobile application is installed. In this case, the feedback is an instruction to replace the advertisement with another advertisement, for instance, an advertisement for another recommended mobile application. This feedback can be sent from one or more servers administering the download and installation of the emulator and the mobile application, and the user account that is created.

A server can be in communication with the application providing replaceable graphical representations. The server can be connected to a database containing user preference data. Such user preference data can be personal or analysed user preference data generated after analysis of many users' preference data. User preference data may be obtained from data from browser related profiling or obtained from organizations that collects user preference data. For example, user preference data may include what categories a user would be interested in, what kind of products, services and/or applications a user may be interested in etc. For a computer or mobile device gamer, he or she may be interested in games of certain genres and therefore, the logo or trademark of games of such genres may be pushed by the server to the apparatus of the gamer to be displayed as an icon or a banner on the home screen by the application. A video clip of a game that may be of interest to the user may also be pushed to the apparatus of the gamer to be displayed as a video on the home screen by the application. The application may be configured to receive a feedback from the server if a product, service or application is already purchased, downloaded or installed to prevent a logo, trademark or video clip related to such product, service or application from displaying. A check may also be performed by the application to check whether a product, service or application is already purchased, downloaded or installed to prevent a logo, trademark or video clip related to such product, service or application from displaying.

The server may also be configured to push content to the application providing replaceable graphical representation upon request or under the instructions of marketers, promoters, advertisers and/or sponsors. For example, the launch of a new game, application, product or service, sales or discounts, web and/or application related events, etc.

One or more of the abovementioned graphical representations may be configured to appear in a form of a pop-up window displayed on the home screen. The application providing replaceable graphical representation may be configured such that the pop-up window omits borders and resembles a standalone application feature. Such borders typically include menu options, close window option, expand window option, minimise window option, and/or a frame surrounding all sides of the window. The omission of such borders will make a banner appear cleaner and not resemble a typical browser page with borders that is flashing the banner, make a wallpaper look like what it should be i.e. wallpapers typically do not have borders, and make a video appear like a standalone video display instead of a video being played on a typical browser page.

To implement the abovementioned pop-up window without borders, for example, tools such as Microsoft Edge WebView2 may be used. Microsoft Edge WebView2 allows embedding of web technologies such as HTML, CSS, and JavaScript in a native Windows application. Microsoft Edge WebView2 uses Microsoft Edge as a rendering engine to display web content in the native Windows application. For example, the web content of a graphical representation in the form of an icon, a banner or wallpaper can be an image pull from a web source, the web content of a graphical representation in the form of an interactive banner or wallpaper can include JavaScript pull from a web source, the web content of a graphical representation in the form of an icon can be an image pull from a web source, the web content of a graphical representation in the form of an icon can be an image pull from a web source. Specifically, Microsoft Edge WebView2 provides a WebView control for displaying web content in Windows Forms and/or WPF desktop application, “WPF” refers to Windows Presentation Foundation, which is a User Interface (U1) framework that creates desktop client applications. This is one of several wrapped Universal Windows Platform controls that are available for Windows Forms and WPF applications. Removal of said borders can be configured using such tools. Using such tools, for example, a video from a web source can be pushed and streamed to the home screen to be displayed in full screen or in a window without borders and, for example, a mouse cursor can be used to select or click on the displayed video to take actions such as to open a web page to present one or more advertisements.

To implement the abovementioned interactive graphical representations providing access to a virtual place, for example, tools such as WebGL, which can be said to be a port of OpenGL to a browser, can be used. Specifically, WebGL is a set of JavaScript Application Programming Interfaces (API) that can render 3 Dimensional (3D) scenes onto a HTML canvas. Generally, such APIs are built directly into a browser's JavaScript engine and do not require plugins.

More examples of the present disclosure will be described with reference to figures below.

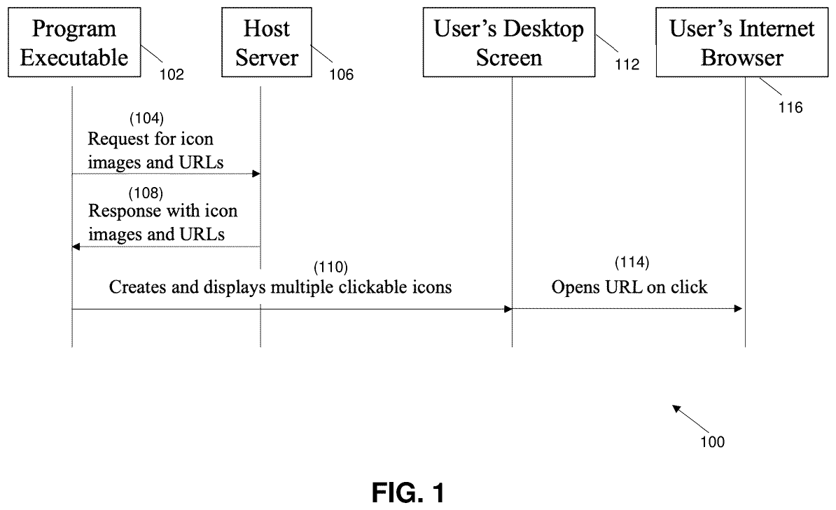

FIG. 1 is a flowchart 100 illustrating a method of a program 102, which is an application providing a plurality of replaceable graphical representations on a home screen of an apparatus. In the example of FIG. 1, the apparatus is a personal computer with Windows Operating System and the home screen is a desktop screen 112 of the personal computer. When a user starts the computer, the program 102 executes at start up. Upon execution of the program 102, the program 102 requests for information from a host server 106 at a step 104. Step 104 can happen during start up and/or any time after start up. The information comprises graphical representations, for example, a plurality of icon images, and URLs associated with the icon images. In this case, a URL associated with an icon image refers to a URL of a web page that will open on an internet browser 116 upon selection of the icon image. After the request, at a step 108, the host server 106 responses to the request by sending the requested information to the program 102. Next, at a step 110, the program 102 creates icons from the icon images for displaying on the desktop screen 112. The program 102 configures the icons such that selecting or clicking the icons on the desktop screen 112 would activate the internet browser 116 to open the respective URLs that are associated with the icons at a step 114. The icons can be replaced by the program 102 based on a time duration provided with the requested information. For instance, this time duration may expire as soon as an icon is selected or clicked, or expire after the application receives an instruction from the host server 106 to replace the icon.

Alternatively, the program 102 may simply display whatever the host server 106 provides and instructs, and the settings at the host server 106 decides the time duration to have each icon displayed on the desktop screen 112. The information of graphical representations to be displayed on the desktop screen 112 may be stored on and managed by the host server 106.

The host server 106 may instruct replacement to the program 102 when the information is updated.

The program 102 may be programmed to rotate the displaying of a plurality of icons at a specific location of the desktop screen 112.

In the present example, when an icon is replaced, it will be changed to display a different icon from the icon previously displayed, and the new icon is selectable to open a different web page.

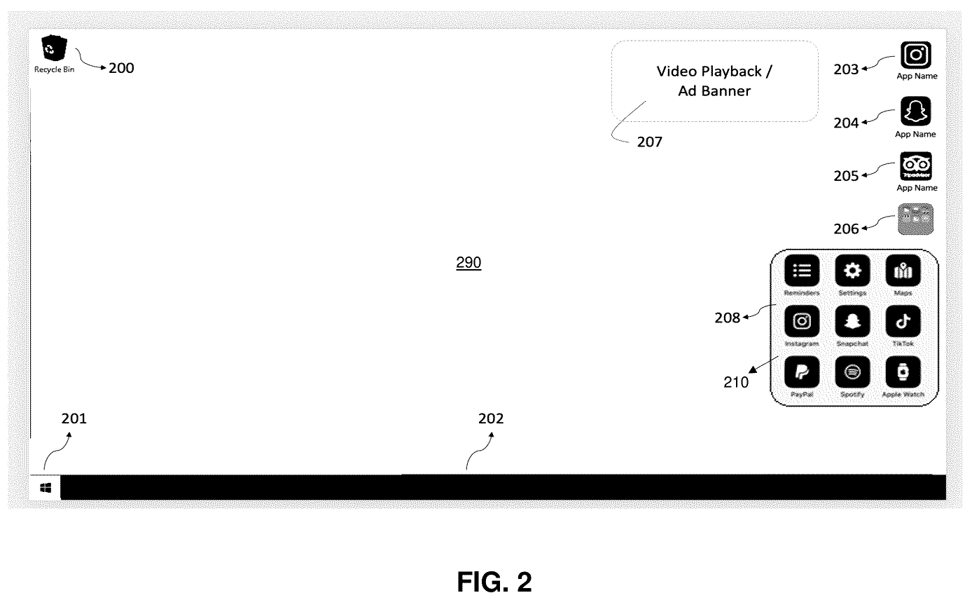

FIG. 2 shows an example of a desktop screen 290 in landscape orientation and the program 102 described earlier is executed at the start up of the computer to display a plurality of graphical representations. Reference is made to the elements of FIG. 1 in the following description. Specifically, the desktop screen 290 displays typical desktop features such as a typical desktop icon 200, a start button 201 and a taskbar 202 of a graphical user interface of the Windows Operating System at a bottom of the desktop screen 290. The program 102 displays a plurality of icons 203, 204, 205, and 206 in the desktop screen 290, and displays a video or an advertisement banner in a space 207 in the desktop screen 290. The typical desktop icon 200 is not under the control of the program 102. Different from the example of FIG. 1, in addition to displaying icons, the program 102 also displays the icon 206 and the video or advertisement banner.

In the present example, the icons 203 to 205 are related to different predetermined categories. In the present example, the icon 203 is related to a social media category 203, the icon 204 is related to an entertainment category 204 for playing a game, and the icon 205 is related to the travel category. Selecting or clicking each icon would open a web page associated with it. For example, clicking the icon 203 would open a web page for accessing a user's social media account or to a web page advertising a social media application and encouraging a user to download and install it. Clicking the icon 204 would execute a game to play or open a web page advertising a game application and encouraging a user to download and install it. Clicking the icon 205 would for example, open a web page containing available hotel rooms for booking. The web pages are opened via the internet browser 116.

The icon 206 displayed by the program 102 is a folder icon, which will open a folder window 208 (which is an expanded view) containing a plurality of selectable icons 210 after the icon 206 is selected or clicked. Each of the plurality of selectable icons 210 is selectable to perform one or more user actions such as to open a web page, execute an application, download something, add something to a web cart or store etc. The icon 206 illustrates that the program 102 can be configured to allow a plurality of icons to be grouped together in a manner which can be user defined or predefined by the host server 106. For example, the grouping may be based on categories. The folder window 208 can be showing a web page comprising the plurality of selectable icons 210, or a native folder window of an Operating System (OS) (e.g. a folder of Windows OS or MacOS) containing the plurality of selectable icons 210. The web page comprising the plurality of selectable icons 210 may be running a web application enabling the plurality of selectable icons 210 to be selectable. A folder icon like icon 206 may be created as required by a user and one or more icons displayed by the program 102 may be copied or cut and placed into the created folder icon. The icons may also be dragged and dropped to the created folder icon. In another example, icons may be dragged and dropped to each other to form the folder icon containing the icons.

The space 207 may show a window displaying a video playback or the advertisement banner. A plurality of the icons 203 to 206, and a plurality of such window for displaying the video or banner can be displayed on the desktop screen 290. Similar to the icons described for FIG. 1, the information of the video or banner may be provided by the host server 106 upon request by the program 102 during start up or while the program 102 is running after start up, or provided by the host server 106 to the program 102 when such video or banner is available. The video or banner information provided by the host server 106 may contain for instance, a web source of the video (e.g. URL with a video file extension) or banner (e.g. URL with an image file extension) and the program 102 is configured to play the video or display the banner image accordingly. The video may be displayed in full screen or substantially full screen temporarily, or smaller than full screen and looped to be played repeatedly until it is changed to another video or another graphical representation.

The program 102 displays the icons 203 to 206, the folder window 208, the video or banner at the space 107 at locations in the desktop screen that do not interfere (or try not to interfere as much as possible) with the typical desktop features.

The program 102 may be configured to periodically request the host server 106 for an update on information of graphical representations to be displayed. If there are no updates, the graphical representations currently displayed will continue to be displayed. However, if there is an update, for instance, there is a new advertisement for travel category, a new travel related icon can be sent to the program 102 for replacing the icon 205, which is at a location for displaying travel related icons. Alternatively, instead of the program 102 periodically sending a request, the host server 106 may be configured to push new information of graphical representations to be displayed to the program 102 when there is an update. However, preferably, the program 102 should take initiative to request for the information of graphical representations to be displayed during start up of the apparatus because this request will notify the host server 106 that the program 102 is activated.

In FIG. 2, the graphical representations (i.e. 203 to 208) are displayed on the right side of the desktop screen 290 in order not to interfere with the use of the existing icon 200. They are also not placed in the taskbar 202 and thus does not limit the space provided by the taskbar 202. The graphical representations (i.e. 203 to 208) are movable to any other part of the desktop screen 290. For instance, the program 102 can be configured to allow a user to move them by dragging and dropping them using a mouse cursor or through touch input in the case of a touchscreen.

In the example of FIG. 2, the icons 203, 204 and 205 are replaced on a periodic or regular basis with other icons related to the same categories as the icons 203, 204 and 205 respectively. Similarly, the plurality of selectable icons 210 shown in 208 are also replaced on a periodic or regular basis with other icons. If the folder icon 206, and its expanded window 208, only contains icons related to one category, it may be configured that the plurality of selectable icons 210 is replaced only by other icons of the same category. If the folder 206, and its expanded window 208, contains icons related to more than one categories, then it may be configured that the plurality of selectable icons 210 is replaced by other icons of such more than one categories respectively.

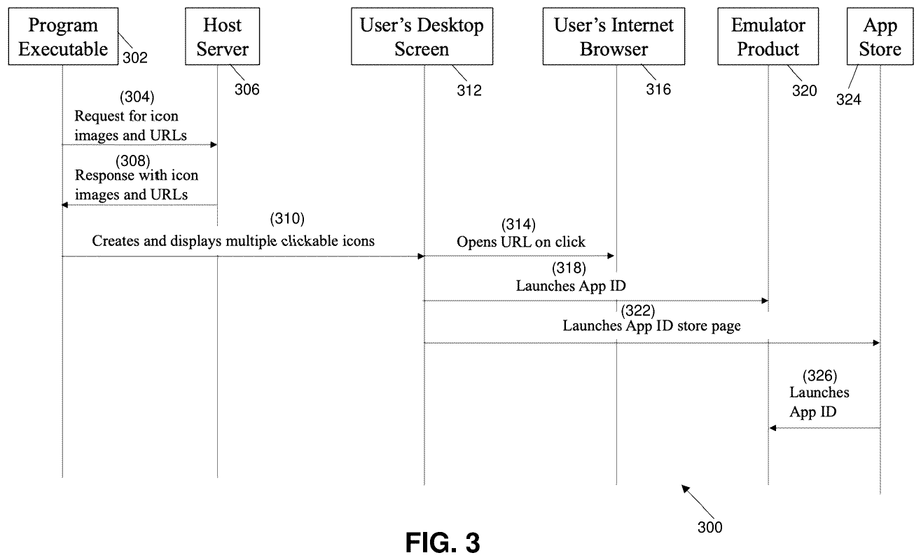

FIG. 3 is a flowchart 300 illustrating a method of a program 302, which is similar to the program 102 of FIG. 1 but has functions for interacting with an example of the emulator described earlier, which is known as the emulator product 320 in FIG. 3. Like the program 102, the program 302 is an application providing a plurality of replaceable graphical representations on a home screen of an apparatus. The apparatus is a personal computer with Windows Operating System and the home screen is a desktop screen 312 of the personal computer. The emulator product 320 is a program that can be executed natively by the Windows Operating System. The emulator product 320 may be already installed on the apparatus or to be downloaded from a web source and installed if it is not already installed. It is assumed for the example of FIG. 3 that the emulator product 320 is already installed on the apparatus and is executed during the start up of the apparatus. The program 302 can be the emulator product 320 itself or a standalone program 302 configured to work with the emulator product 320.

When a user starts the apparatus, the program 302 executes at start up. Upon execution of the program 302, the program 102 requests for information from a host server 306 at a step 304. Step 304 can happen during start up and/or any time after start up. After the request, at a step 308, the host server 306 responses to the request by sending the requested information to the program 302.

In the present example, the requested information comprises a plurality of icon images, and URLs associated with the icon images.

At a step 310, the program 302 creates icons from the icon images for displaying on the desktop screen 312. The program 302 may be programmed to rotate the displaying of a plurality of icons at a specific location of the desktop screen 312.

The icons will be replaced by the program 302 when predetermined conditions are satisfied. For example, a time duration for each icon to be displayed can be provided with the requested information and the program 302 replaces an icon once the time duration expires. In another example, an icon may be replaced after it is selected or clicked. In a further example, the program 302 may replace the icon after receiving an instruction from the host server 306. In yet another example, an icon may be replaced after it is selected or clicked and the program 302 receives an instruction from the host server 306 to replace it.

One of the icons may show an image associated with a web page having a URL provided in the information from host server 306 and the web page is to be displayed after the icon image is selected. In this case, the process will be similar to that of FIG. 1, which is the program 302 will activate an internet browser 316 to open the web page at a step 314 after the icon is selected on the desktop screen 312.

One of the icons may show an image associated with an application to be executed by the emulator product 320, and the icon has an application identifier (App ID) associated with it. This App ID will facilitate the downloading and installation of the application to be executed by the emulator product 320. The example of FIG. 3 illustrates this process.

In the case that an icon associated with an application to be executed by the emulator product 320 is selected, step 314 will not take place. Instead, the program 302 will send the application identifier (ID) of the application to be executed by the emulator product 320 to the emulator product 320 at a step 318. This notifies the emulator product 320 that the application with this application ID is to be installed and executed. This application ID is provided with the information accompanying the icon image that is obtained from the host server 306.

In the case that the emulator product 320 is not executed yet, the program 302 may instruct the execution of the emulator product 320 and then send the application ID to the emulator product 320 at the step 318.

In the case that the emulator product 320 is not installed yet, the program 302 may activate the internet browser 316 to open a web page to facilitate the downloading and installation of the emulator product 320. Thereafter, the program 302 instructs the execution of the emulator product 320 and then send the application ID to the emulator product 320 at the step 318.

The program 302 also instructs an application (App) store 324 to launch a store page associated with the application having the application ID at a step 322. The store page may be displayed in a window on the desktop screen 312 to facilitate the downloading of the application. For instance, a user may be required by the store page to login to or register for a user account before the downloading of the application can commence. The application (App) store 324 can also be known as an application store application.

In the case that the App store 324 is not executed yet, the program 302 may instruct the execution of the App store 324 and then instructs the App store 324 to launch a store page associated with the application having the application ID at a step 322.

In the case that the App store 324 is not installed yet, the program 302 may activate the internet browser 316 to open a web page to facilitate the downloading and installation of the App store 324. Thereafter, the program 302 instructs the execution of the App store 324 and then instruct the App store 324 to launch a store page associated with the application having the application ID at the step 322.

In another example, the displaying of the store page may be omitted and the downloading of the application commences without user login or registration. For instance, the store page may appear once if the user is new and has no user account but the store page may no longer appear after the user registers for a user account. The application store program 324 may be configured to remember that the store page no longer needs to be displayed once the user has registered and activated a user account. Alternatively, there is no need to login or create user account and the downloading of the application commences without the store page being displayed.

After the application is downloaded with the help of the App store 324, the App store 324 instructs the emulator product 320 to install and execute the downloaded application at a step 326. In another example, the program 302 may instruct the emulator product 320 to install and execute the downloaded application at the step 326 instead of the App store 324.

If the displaying of the store page is skipped, the downloading, installation and execution of the application will appear to be seamless.

It should be appreciated that the App store 324 can be part of the emulator product 320 or a standalone program. The application store program 324 may also be a web application hosted by a server or a program locally run by the apparatus.

Furthermore, if the program 302 and the emulator product 320 are separate programs, the emulator product 320 may be configured to instruct the program 302 to replace the selected icon with another graphical representation (e.g. another icon image associated with an application executable by the emulator). Alternatively, the emulator product 320 may update the host server 306 and the host server 306 instructs the program 302 to replace the selected icon with another graphical representation (e.g. another icon image associated with an application executable by the emulator). If the program 302 and the emulator are the same program, the program 302 may request the host server 306 to provide information of another graphical representation (e.g. another icon image associated with an application executable by the emulator) to replace the selected icon.

In another example, one of the icons may show an image associated with the emulator product 320 and selecting the icon will open a web page to facilitate the downloading and installation of the emulator product 320.

In a further example, the program 302 may be configured to determine whether the emulator product 320 and/or the App store 324 are installed. If the emulator product 320 and/or the App store 324 are not installed, and an icon associated with an application to be executed by the emulator product 320 is selected, the program 302 will activate the internet browser 316 to open a web page to facilitate the downloading and installation of the emulator product 320 and/or the App store 324 respectively. Once the emulator product 320 and the App store 324 are installed and executed, the steps 318, 322, and 326 can commence.

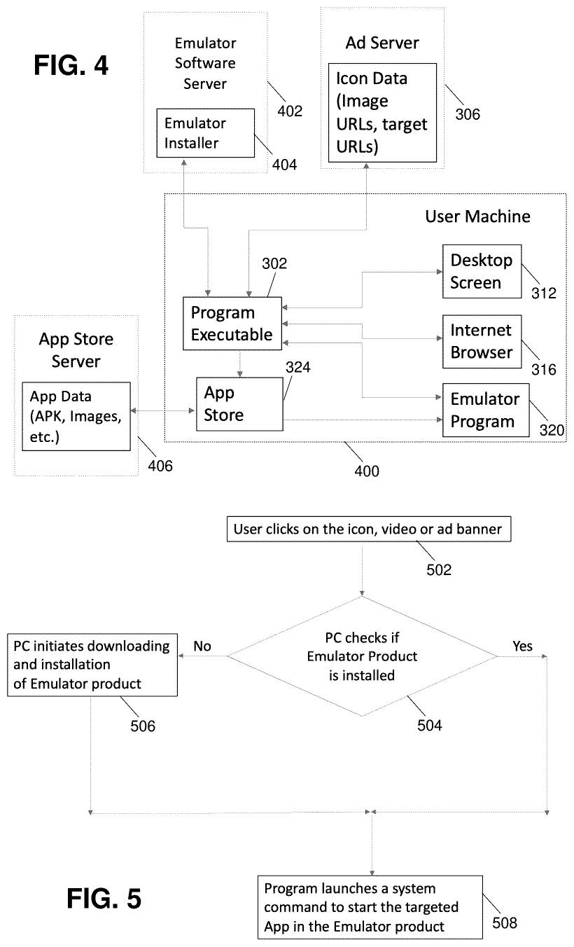

FIG. 4 shows an example of a system architecture of the example of FIG. 3. The same elements in both FIG. 3 and FIG. 4 are given the same reference numerals. The computer described with reference to FIG. 3 is known as a user machine 400 in FIG. 4, the host server 306 is known as an advertisement server 306 (Ad Server) in FIG. 4, and the emulator product 320 is known as an emulator program 320 in FIG. 4. The user machine 400 is installed with the program 302, the App store 324, the emulator program 320, and the internet browser 316. The user machine 400 displays the desktop screen 312 in a display after starting up.

The program 302 is configured to communicate with the Ad Server 306 to obtain icon data such as icon images, App ID associated with the icon data, and if applicable, target URL corresponding to each icon image. The program 302 can request for such data from the Ad Server 306 upon execution during the start up of the user machine 400. The program 302 is configured to display the icon images on the desktop screen 312 after the icon data are obtained. The program 302 may be configured such that selecting some icons may trigger the internet browser 316 to display a web page. Selecting some icons may trigger the downloading and installation of the emulator program 320 and/or App store 324 if the emulator program 320 and/or the App store are not installed. Selecting some icons may trigger the App store 324 to facilitate the downloading of an application to be executed by the emulator program 320 from an application store server 406. After the application is downloaded, either the program 302 or the App store 324 will instruct the emulator program 320 to install and execute the application.

The program 302 is configured such that selecting one of the icons triggers the downloading and installation of the emulator program 320 if it is not installed, triggers the downloading and installation of the App store 324 if it is not installed, triggers the execution of both the emulator program 320 and the App store 324, and triggers the App store 324 to download an application to be executed by the emulator program 320. Thereafter, either the program 302 or the App store 324 will instruct the emulator program 320 to install and execute the application.

If the emulator program 320 is not installed, the program 302 will activate an emulator installer 404, which is a server application of an emulator software server 402 distributing the emulator program 320. The emulator installer 404 will facilitate the downloading and installation of the emulator program 320. The App store 324 may be part of the emulator program 320 and is installed with the emulator program 320.

FIG. 5 illustrates an example of an emulator installation checking process of the program 302 of FIG. 3 and FIG. 4. The following description refers the elements described with reference to FIG. 3 and FIG. 4. At a step 502, a user clicks on an icon, video or advertisement banner directed to a targeted application executable by the emulator product 320. Thereafter, the program 302 running on the personal computer (PC) instructs the PC to check if the emulator product 320 is installed at a step 504. In the example of FIG. 5, the App store 324 is part of or a feature of the emulator product 320 and installing the emulator product 320 will also install the App store 324.

If the check at step 504 indicates that the emulator product 320 is not installed, the program 302 instructs the PC to initiate downloading and installation of the emulator product 320 at a step 506. The PC will communicate with the emulator software server 402 and activate the emulator installer 404 to facilitate with the installation of the emulator product 320. Once the emulator product 320 is installed and executed upon installation, the targeted application will be installed with the help of the App store 324. Thereafter, the program 302 will launch a system command to activate the emulator product 320 to start or execute targeted application start or execute a targeted application that is executable by the emulator product 320 at the step 508.

If the check at step 504 indicates that the emulator product 320 is installed, the targeted application will be installed with the help of the App store 324. Thereafter, the program 302 will launch a system command to activate the emulator product 320 to start or execute the targeted application at a step 508.

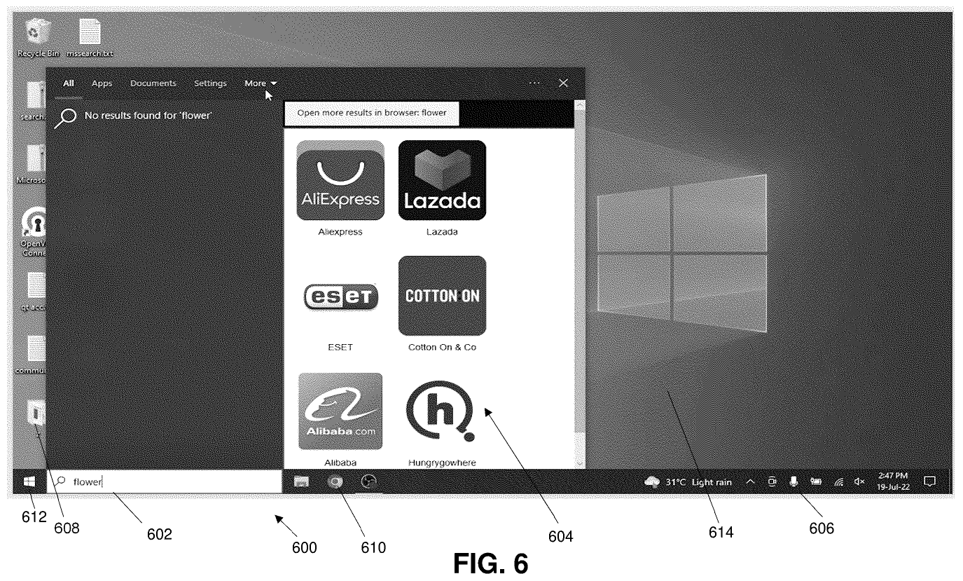

FIG. 6 shows an example of the desktop screens 112 and 312 described earlier. FIG. 6 illustrates a desktop screen 600 with features that a program similar to program 102 and 302 described earlier may be configured to provide. Specifically, graphical representations, in this case icons 610, are displayed by the program in a taskbar 606 located at a bottom of the desktop screen 600 and not in a space 614 above the taskbar 606, which displays pre-existing icons 608. Therefore, the space 614 above the taskbar 606 and the pre-existing icons 608 are not affected by the icons 610. This is different from the example of FIG. 2, which displays graphical representations in the space above the taskbar 202 and the space in the taskbar 202 is not taken up by the displayed graphical representations.

Although the examples in FIG. 2 and FIG. 6 show the placement of the graphical representations at different locations, it should be appreciated that in another example, the graphical representations can be placed both in the taskbar 606 and in the space 614 above the taskbar 606. However, in whichever example of the present disclosure, the graphical representations should be placed as much as possible in a manner without preventing accessibility to (or provide to provide minimum interference to) at least one pre-existing features displayed on the desktop screen 600, such as the taskbar 606, pre-existing icons 608, start button 612, etc. This means that, for example and where possible, the graphical representations should try not to overlap the pre-existing icons 608, the entire space of the taskbar 606 should not be fully taken up, there should be a limited number of graphical representations being displayed (e.g. at most two banner or video, four icons of different categories, etc.), full screen video should only be displayed temporarily, etc.

The program of FIG. 6 may be configured to enable the icons provided by a host server similar to the host servers 106 and 306 to be searched. Specifically, the program may be configured to provide a search function 602 for a user to enter keywords to search for relevant icons 604 provided by the host server. For example, a user may enter “flower” in a text box of the search function 602 and all the icons 604 relevant to “flower” would appear in a window containing the icons 604. For example, the icons 604 may be hyperlinks to shopping website or applications that sell flowers. The icons 604 discovered via the search function 602 can include one or more of the icons (e.g. the icons 610) already displayed on the desktop screen 600, and one or more icons with information already downloaded (from the host server) to the apparatus executing the program 102 and 302 but not displayed. Some of the icons 604 may be downloaded to the apparatus only during the search. The icons 604 discovered during the search may be replaceable like the icons 610 displayed by the program. For example, the icons 604 discovered may be replaced by other icons, removed, and/or new icons may be discovered during searches performed at different time. The icons that are discoverable via the search function 602 can be controlled by the host server and/or the program. Each of the icons 604 are displayable on the home screen by the program.

In one example, one or more of the displayed icons 610 may be replaced by one or more of the icons 604 discovered via the search function 602 after the search is performed. For instance, a user may select one or more of the icons 604 to replace the displayed icons 610. Alternatively, the program may automatically replace one or more of the displayed icons 610 with one or more of the icons 604 after the search is performed.

Furthermore, a displayed icon 610 may be changed by interacting with it. For instance, it can be selected not just to open a web page, run an application, etc. but to change into another icon.

Note that the search function 602 can be provided regardless of the display location of the icons 610. Hence, it can also be provided for the example of FIG. 2.

In one example, only the search function 602 is made available by the program after start up and the program of FIG. 6 is configured to display graphical representations only after a search is performed using the search function 602. The search function 602 can be incorporated with an existing search function available in the operating system of the apparatus executing the program of FIG. 6. For instance, the start button 612 provided by the Windows Operating System provides access to a search feature. The search function 602 can be a modification of such search feature to enable the displaying of the graphical representations after a search.

There can be a plurality of modes selectable via user settings to switch between different modes of displaying the graphical representations. For example, the program of FIG. 6 may be programmed such that the selectable modes of placement of the graphical representations are two or more of the following: 1) placement in the taskbar 606 only, 2) placement only in the space 614 above the taskbar 606, 3) placement in both taskbar 606 and the space above the taskbar 606, 4) display graphical representations only after a search is performed using the search function 602, 5) interactive or non-interactive wallpaper containing graphical representations, and 6) display only one replaceable graphical representation (e.g. at a center of the taskbar 606) and provide the search function 602.

Although icons are described in the example of FIG. 6, other types of graphical representations such as banner, video, etc. are also applicable.

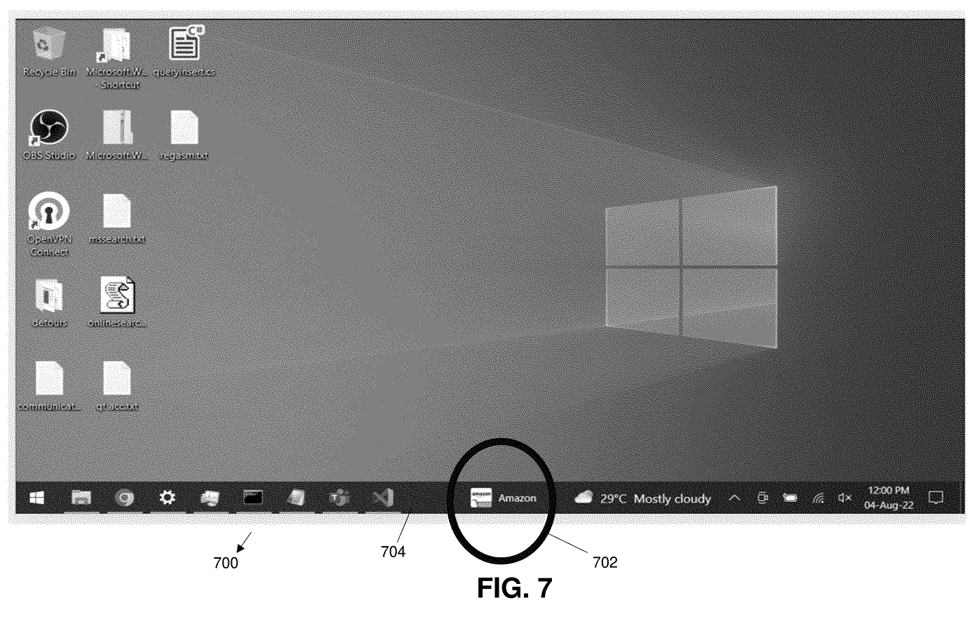

FIG. 7 shows an example of a desktop screen 700, in which an example of the application (or program) providing replaceable graphical representation described earlier is configured to have minimum interference to the pre-existing desktop features. In the example of FIG. 7, there is just one replaceable graphical representation 702, provided at a central location in the taskbar 704. The graphical representation 702 is an icon selectable to open a web page linked to an online shopping website. It is replaceable periodically to show other icons that are hyperlinked to other websites, or links to download, install, or run certain applications.

In one example, the one or more graphical representations (e.g. 702) displayed by the application (or program) providing replaceable graphical representation may be selected to hide, remove, and appear upon user selection. There can also be an option to switch off the application. For example, a user may right click one graphical representation using a mouse, to select to hide it, remove it, switch on the application if it is off, or switch off the application to stop displaying any graphical representation, from a menu.

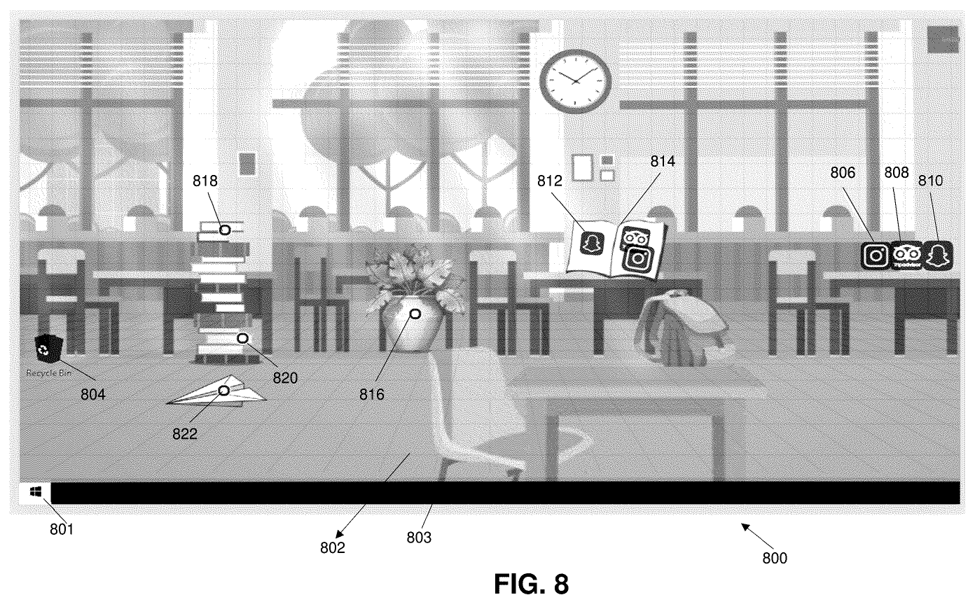

FIG. 8 shows an example of a desktop screen 800, in which an example of the application (or program) providing replaceable graphical representation described earlier is configured to display an interactive graphical representation 802 containing other graphical representations 806 to 822 within it. The interactive graphical representation 802 is a wallpaper displayed in the background and it does not prevent accessibility to pre-existing features of the desktop screen 800 such as a recycle bin icon 804, a taskbar 803 and start button 801. Each of the graphical representations 806 to 822 are selectable by a user, for instance, using a mouse cursor to perform one or more actions. The one or more actions may be to open one or more web pages, execute or run one or more applications, download and/or install one or more applications, or add an item to a cart (e.g. shopping cart for online purchases). In the present example, the graphical representations 806 to 822 comprise icons related to different categories.

The interactive features of the example of FIG. 8 are described as follows. The application is configured to allow a user to have a three dimensional (3D) desktop billboard experience, in which graphical representations such as application icons (e.g. applications executable by the emulator and emulator product/program 320 described earlier), shortcut icons to open web pages, banners, videos, keyword contextual targeting advertisements, and/or advertisements can be provided in different locations within the 3D space. Such 3D space is same as the virtual place described earlier for interactive graphical representations, wherein the user may move within the virtual place. Specifically, the 3D desktop billboard experience allows the user to move in X-Y-Z axis direction within the 3D space, and zoom in and out of the 3D space to discover more application icons (that change at pre-set timing or whenever there is new content), shortcut icons, expandable video (i.e. expandable to full screen or partially cover the screen upon selecting), banner containing advertisement that are either static or clickable to open one or more web pages, and/or items that display advertisements when the user hovers over the items and/or click on them. Note that hovering over the items constitutes user selection. Such movements may be performed via mouse input and/or keys of a keyboard (e.g. arrow keys). Each graphical representation can allow a user to do one or more of the following:
(i) Launch branded websites on a browser;
(ii) Download, install and launch Mobile software (with file extensions such as apk, ipa etc.) with the aid of the emulator and emulator product/program 320 described earlier; and
(iii) Download, install and launch Application (with file extensions such as exe, dmg etc.)

The virtual place of the interactive wallpaper 802 of FIG. 8 is a classroom. The user may move around the classroom via arrow keys of the keyboard and/or via the mouse cursor. The user may also exit the classroom to explore places outside of the classroom. Different graphical representations may be located at different locations of the classroom and in the world outside of the classroom. The interactive wallpaper 802 is configured to be activatable to enable user interaction with the virtual place, to enable selection of graphical representations, or to disable such user interaction or selection. If the user interaction and selection are disabled, the interactive wallpaper 802 will become a conventional wallpaper as long as the application providing replaceable graphical representation is running. The 3D space or virtual place can be programmed in Javascript, Solidity, Vyper, Python, Rust etc. as a web application or a desktop application (e.g. programmed as a feature of the application providing replaceable graphical representation).

In FIG. 8, the graphical representations 806, 808 and 810 serve as advertisements to encourage a user to use applications executable by an emulator. Each of them is selectable by a user to:
send to an emulator, an application identifier associated with an application that is executable by the emulator, wherein the application identifier informs the emulator which application is to be executed;
download and install the emulator if it is not installed;
download and install the application associated with the application identifier if it is not installed; and
activate the emulator to execute the application associated with the application identifier.

FIG. 8 shows a graphical representation 814, which appears as a book. It can act as a folder containing other graphical representations 812 when it is selected. For example, clicking the graphical representation 814 flips pages of the book and different pages may show different graphical representations 812. As there can be a limit to the number of the graphical representations 812, the graphical representations 812 that are displayed may repeated after flipping a predetermined number of pages.

Examples of keyword contextual targeting advertisement are the graphical representations 816 directed at a potted plant, 818 directed at a book, 820 directed at another book, and 822 directed at a paper aeroplane. For example, hovering over or clicking the graphical representation 816 may show an advertisement directed to potted plant sales and/or provide information on potted plants. Hovering over or clicking the graphical representations 818 and 820 may show an advertisement directed to sale of specific books, and/or electronic books ready to be read. Clicking or hovering over the graphical representation 822 may open or show glimpses of an advertisement, which can be a web page on origami, or even a web page on air travel.

The application providing graphical representation can be configured to provide a user console to switch on and off the interactive features described above.

The application providing replaceable graphical representation described in examples of the present disclosure may be configured to gather or determine user preference data from a user's usage of the application. For example, number of times a user selects graphical representations of a specific category, user settings on the preferred graphical representations to be displayed, user settings on preferred mode of display of the graphical representations, etc. Such user preference data, for example, higher or lower selection frequency for each category, can determine how to modify time duration or frequency of displaying certain graphical representations, determine removal or replacement of the graphical representation, etc.

Optionally, the application providing replaceable graphical representation may work with a computer neural network in which machine learning can be involved. This computer neural network can be of the type that involves deep learning. This computer neural network may be hosted by the application providing replaceable graphical representation, one or more servers in the network, or one or more servers outside the network. Artificial Intelligence (A.I.) can be used to predict user preference based on the user's usage of the application providing replaceable graphical representation. One or more A.I. models for different purposes can be provided by the computer neural network, and these one or more A.I. models can be updated to further train the one or more respective A.I. model to be more accurate.

With regard to the emulator and the emulator product/program 320 described earlier, it can be configured as a node in a plurality of node in a network (e.g. a biockchain network, internet, etc.). The network may reward users for usage of software executable by the emulator, and rewards are given based on time spent using the software. The network may comprise a plurality of verification nodes to verify that the time spent for software usage is genuine. The rewards may be coins (e.g. cryptocurrency), tokens (e.g. fungible or non-fungible tokens), assets (e.g. software related resources such as credits of a specific game that are exchangeable for game items), etc.

The applications executable by the emulator can include an application modified from an existing application (for example, an existing Android mobile app). In this case, the emulator will improve the existing application by providing additional functionalities to the modified application. For example, if the application providing replaceable graphical representation is part of or integral with the emulator, the emulator can provide the features of the application.

The emulator can also provide a functionality to an application executable by it to enable the user of the application to access a platform to engage in multi-user interactions with one or more other users accessing the same platform through one or more other applications configured to access this common platform. Chat/Messaging capabilities can be provided by the emulator to enable users to interact when they login to the platform. Trading of coins, tokens and/or assets can take place in the platform as well. Furthermore, the emulator may be configured to monitor status of the application executed by it, push content relating to replacement, addition or removal of graphical representations, and/or gather data from the contents of the application to identify one or more specific points in the runtime of the application to push content to the application.

Details of an example applicable to the apparatus, node, and/or the server (which can be a server computer) described in all the examples of the present disclosure are as follows. The apparatus may be a user or client device and can communicate with one or more user or client device and/or one or more servers via the Internet. The apparatus may be a personal computer, a desktop computer, a video game console, a smart television (TV), a TV box, or similar device (e.g. android box), a portable or laptop computer, a smartphone, a tab or pad device, and the like. The apparatus of the present example may have one or more of the following components in electronic communication via a suitable bus:
1. a display;
2. non-volatile memory;
3. random access memory (“RAM”);
4. N processing components (“one or more processors”);
5. a transceiver component that includes N transceivers;
6. user controls i.e. user input devices;
7. optionally, image capturing components (e.g. camera);
8. optionally, audio signal capturing components;
9. optionally, audio speakers; and
10. Input/Output interfaces for connecting to the user input devices (such as mouse, joystick, keyboard, sensors for detecting user gestures, and the like), the audio speakers, image capturing components and/or audio signal capturing components.

The display generally operates to provide a presentation of graphical content (e.g. the one or more graphical representations, graphical contents of the mobile device software and/or application executed after selection of the one or more graphical representations, the one or more web pages, and/or advertisements herein described) to a user, and may be realized by any of a variety of displays (e.g., CRT, LED, LCD, HDMI, micro-projector and OLED displays). The display may be a touchscreen and considered as one of the Input/Output interfaces as it is able to receive user inputs.

In general, the non-volatile memory functions to store (e.g., persistently store) data and executable code, instructions, program or software including code, instructions, program or software that is associated with the functional components of a browser component and applications. The code, instructions, program or software includes, for instance, the program 102 described earlier or the application providing replaceable graphical representation described in the present disclosure. In one example, the code, instructions, program or software may provide an emulator for running mobile applications, if the operating system of the apparatus is not natively configured to run mobile applications. In some examples, the code, instructions, program or software may include Information Technology security code, bootloader code, modem software, operating system code, file system code, and code to facilitate the operation of the apparatus as well as other components well known to those of ordinary skill in the art that are not depicted for simplicity. Furthermore, the code, instructions, program or software may provide software to enable the apparatus and/or server to participate as a node with predefined functionalities in a blockchain network.

In many implementations, the non-volatile memory is realized by flash memory (e.g., NAND or NOR memory), but it is certainly contemplated that other memory types may be utilized as well. Although it may be possible to execute the code from the non-volatile memory, the executable code in the non-volatile memory is typically loaded into RAM and executed by one or more of the N processing components.

The N processing components (“or one or more processors”) in connection with RAM generally operate to execute the instructions stored in non-volatile memory to effectuate the functional components. As one skilled in the art (including ordinarily skilled) will appreciate, the N processing components may include a video processor, modem processor. DSP, graphics processing unit (GPU), and other processing components. In some implementations, the processing components are configured to determine a type of software activated on the apparatus.

The transceiver component may include N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks, 5G network etc.), and other types of communication networks. In some implementations, the communication of the transceiver component with communication networks enables a location of the apparatus to be determined.

The image capturing components and the audio signal capturing components that are optionally available can also be utilised to input user controls, as defined control settings.

The processing of the executable code, instructions, program or software may be performed in parallel and/or sequentially. The executable code, instructions, program or software may be stored on any machine or computer readable medium that may be non-transitory in nature. The computer readable medium may include storage devices such as magnetic or optical disks, memory chips, or other storage devices suitable for interfacing with a computer or mobile device. The machine or computer readable medium may also include a hard-wired medium, or wireless medium. The executable code, instructions, program or software when loaded and executed effectively results in the apparatus that implements steps of methods in examples herein described.

Examples of the present disclosure may have the following features. Reference numerals of elements in the figures of the present disclosure that are examples of these features are stated.

A method (e.g. 100, 300) to provide replaceable graphical representation on a home screen (e.g. 112, 290, 312, 600, 700, 800) of an apparatus (e.g. 400), the method comprising: executing, via a processor, an application (e.g. 102, 302) in a memory during start up of an apparatus (e.g. 400) to operate the apparatus to:
display one or more graphical representations (e.g. 203 to 210, 604, 610, 702, 802, 806 to 822) on a home screen (e.g. 112, 290, 312, 600, 700, 800) of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.

The predetermined condition may require the graphical representation to be replaced upon expiry of a predetermined time duration.

The predetermined condition may require the graphical representation to be replaced after the graphical representation is selected.

The predetermined condition may require the application to receive an instruction to replace the selected graphical representation from an apparatus (e.g. 306) external to the apparatus executing the application.

The predetermined condition may require the graphical representation to be selected and the application to receive an instruction to replace the graphical representation from an apparatus (e.g. 306, 402, 406) external to the apparatus executing the application.

The method may comprise:
after executing the application, requesting for contents of the one or more graphical representations to be displayed on the home screen from an apparatus external to the apparatus executing the application.

The one or more graphical representations may comprise an icon (203 to 206, 210, 604, 610, 702, 806 to 812) and a banner or video (e.g. the item filling the space 207) that is selectable by a user to perform the one or more actions.

The one or more graphical representations may comprise a wallpaper (e.g. 802) that displays one or more other graphical representations (e.g. 806 to 822) in it, and the wallpaper is activatable to enable at least one of the one or more other graphical representations in it to be selected to perform the one or more actions.

One of the one or more graphical representations (e.g. 206, 208, 802, 814) may display one or more other graphical representations (e.g. 210, 806 to 822) in it, and at least one of the one or more other graphical representations is selectable to perform the one or more actions.

One of the one or more graphical representations may be configured to display a virtual place (e.g. 802) controllable by a user to move within the virtual place and to display one or more other graphical representations located at different locations in the virtual place.

The one or more actions after selecting one of the one or more graphical representations may comprise one or more of the following:
opening one or more web pages; and
downloading one or more files, or one or more applications.

The method may comprise:
providing a search function (e.g. 602) to enable searching of one or more graphical representations that is displayable on the home screen.

The method may comprise:
replacing the one or more graphical representations discoverable by the search function.

The one or more actions after selecting one of the one or more graphical representations may comprise activating one or more applications, wherein the one or more activated applications comprises an emulator (e.g. 320) configured to execute an application not natively executable by an operating system of the apparatus.

The emulator may be configured to facilitate downloading and installation of an application executable by the emulator, and the application executed to display the one or more graphical representations instructs the emulator to install and execute the application after the application is installed, wherein the selected graphical representation is configured to advertise the downloaded and installed application.

The one or more activated applications may further comprise an application store application (e.g. 324) configured to facilitate downloading of an application executable by the emulator, and the method may comprise:
instructing the emulator to install and execute the downloaded application,
wherein the selected graphical representation is configured to advertise the downloaded and installed application.

The application executed to display the one or more graphical representations may be configured to check whether the emulator is installed and to install the emulator if the emulator is not installed.

The application executed to display the one or more graphical representations may be an emulator (e.g. 320) configured to execute an application not natively executable by an operating system of the apparatus, and the emulator is configured to download, install and execute an application executable by the emulator when one of the one or more graphical representations advertising the downloaded application is selected.

The one or more graphical representations may be categorised, and the method comprises: displaying only one graphical representation per category on the home screen.

An apparatus (e.g. 400) to provide replaceable graphical representation on a home screen of the apparatus, wherein the apparatus comprises:
a processor for executing an application in a memory during start up of the apparatus to operate the apparatus to:
display on a display one or more graphical representations on a home screen of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.

The predetermined condition may require the graphical representation to be replaced upon expiry of a predetermined time duration.

The predetermined condition may require the graphical representation to be replaced after the graphical representation is selected.

The predetermined condition may require the application to receive an instruction to replace the selected graphical representation from an apparatus external to the apparatus executing the application.

The predetermined condition may require the graphical representation to be selected and the application to receive an instruction to replace the graphical representation from an apparatus external to the apparatus executing the application.

The apparatus may be operable to:
after executing the application, request for contents of the one or more graphical representations to be displayed on the home screen from an apparatus external to the apparatus executing the application.

The one or more graphical representations may comprise an icon and a banner or video that is selectable by a user to perform the one or more actions.

The one or more graphical representations may comprise a wallpaper that displays one or more other graphical representations in it, and the wallpaper is activatable to enable at least one of the one or more other graphical representations in it to be selected to perform the one or more actions.

One of the one or more graphical representations may display one or more other graphical representations in it, and at least one of the one or more other graphical representations is selectable to perform the one or more actions.

One of the one or more graphical representations may be configured to display a virtual place controllable by a user to move within the virtual place and to display one or more other graphical representations located at different locations in the virtual place.

The one or more actions after selecting one of the one or more graphical representations may comprise one or more of the following:
opening one or more web pages; and
downloading one or more files, or one or more applications.

The apparatus may be operable to:
provide a search function to enable searching of one or more graphical representations that is displayable on the home screen.

The apparatus may be operable to:
replace the one or more graphical representations discoverable by the search function.

The one or more actions after selecting one of the one or more graphical representations may comprise activating one or more applications, wherein the one or more activated applications comprises an emulator configured to execute an application not natively executable by an operating system of the apparatus.

The emulator may be configured to facilitate downloading and installation of an application executable by the emulator, and the apparatus is operable to instruct the emulator to install and execute the application after the application is installed, wherein the selected graphical representation is configured to advertise the downloaded and installed application.

The one or more activated applications may further comprise an application store application configured to facilitate downloading of an application executable by the emulator, and the apparatus is operable to:
instruct the emulator to install and execute the downloaded application,
wherein the selected graphical representation is configured to advertise the downloaded and installed application.

The application executed to display the one or more graphical representations may be configured to check whether the emulator is installed and to install the emulator if the emulator is not installed.

The application executed to display the one or more graphical representations may be an emulator configured to execute an application not natively executable by an operating system of the apparatus, and the emulator is configured to download, install and execute an application executable by the emulator when one of the one or more graphical representations advertising the downloaded and installed application is selected.

The one or more graphical representations may be categorised, and the apparatus is operable to: display only one graphical representation per category on the home screen.

A non-transitory machine-readable medium storing an application to be executed by a processor during start up of an apparatus to operate the apparatus to:
display on a display one or more graphical representations on a home screen of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.

In the specification and claims, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method to provide replaceable graphical representation on a home screen of an apparatus, the method comprising:
executing, via a processor, an application in a memory during start up of an apparatus to operate the apparatus to:
display one or more graphical representations on a home screen of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.

2. The method as claimed in claim 1, wherein the predetermined condition requires the graphical representation to be replaced upon expiry of a predetermined time duration.

3. The method as claimed in claim 1, wherein the predetermined condition requires the graphical representation to be replaced after the graphical representation is selected.

4. The method as claimed in claim 1, wherein the predetermined condition requires the application to receive an instruction to replace the selected graphical representation from an apparatus external to the apparatus executing the application.

5. The method as claimed in claim 1, wherein the predetermined condition requires the graphical representation to be selected and the application to receive an instruction to replace the graphical representation from an apparatus external to the apparatus executing the application.

6. The method as claimed in claim 1, wherein the method comprises:
after executing the application, requesting for contents of the one or more graphical representations to be displayed on the home screen from an apparatus external to the apparatus executing the application.

7. The method as claimed in claim 1, wherein the one or more graphical representations comprises an icon and a banner or video that is selectable by a user to perform the one or more actions.

8. The method as claimed in claim 1, wherein the one or more graphical representations comprises a wallpaper that displays one or more other graphical representations in it, and the wallpaper is activatable to enable at least one of the one or more other graphical representations in it to be selected to perform the one or more actions.

9. The method as claimed in claim 1, wherein one of the one or more graphical representations displays one or more other graphical representations in it, and at least one of the one or more other graphical representations is selectable to perform the one or more actions.

10. The method as claimed in claim 1, wherein one of the one or more graphical representations is configured to display a virtual place controllable by a user to move within the virtual place and to display one or more other graphical representations located at different locations in the virtual place.

11. The method as claimed in claim 1, wherein the one or more actions after selecting one of the one or more graphical representations comprises one or more of the following:
opening one or more web pages; and
downloading one or more files, or one or more applications.

12. The method as claimed in claim 1, wherein the method comprises:
providing a search function to enable searching of one or more graphical representations that is displayable on the home screen.

13. The method as claimed in claim 12, wherein the method comprises:
replacing the one or more graphical representations discoverable by the search function.

14. The method as claimed in claim 1, wherein the one or more actions after selecting one of the one or more graphical representations comprises activating one or more applications, wherein the one or more activated applications comprises an emulator configured to execute an application not natively executable by an operating system of the apparatus.

15. The method as claimed in claim 14, wherein the emulator is configured to facilitate downloading and installation of an application executable by the emulator, and the application executed to display the one or more graphical representations instructs the emulator to install and execute the application after the application is installed, wherein the selected graphical representation is configured to advertise the downloaded and installed application.

16. The method as claimed in claim 14, wherein the one or more activated applications further comprises an application store application configured to facilitate downloading of an application executable by the emulator, and the method comprises:
instructing the emulator to install and execute the downloaded application,
wherein the selected graphical representation is configured to advertise the downloaded and installed application.

17. The method as claimed in claim 14, wherein the application executed to display the one or more graphical representations is configured to check whether the emulator is installed and to install the emulator if the emulator is not installed.

18. The method as claimed in claim 1, wherein the application executed to display the one or more graphical representations is an emulator configured to execute an application not natively executable by an operating system of the apparatus, and the emulator is configured to download, install and execute an application executable by the emulator when one of the one or more graphical representations advertising the downloaded application is selected.

19. The method as claimed in claim 1, wherein the one or more graphical representations are categorised, and the method comprises:
displaying only one graphical representation per category on the home screen.

20. An apparatus to provide replaceable graphical representation on a home screen of the apparatus, wherein the apparatus comprises:
a processor for executing an application in a memory during start up of the apparatus to operate the apparatus to:
display on a display one or more graphical representations on a home screen of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.

21. The apparatus as claimed in claim 20, wherein the predetermined condition requires the graphical representation to be replaced upon expiry of a predetermined time duration.

22. The apparatus as claimed in claim 20, wherein the predetermined condition requires the graphical representation to be replaced after the graphical representation is selected.

23. The apparatus as claimed in claim 20, wherein the predetermined condition requires the application to receive an instruction to replace the selected graphical representation from an apparatus external to the apparatus executing the application.

24. The apparatus as claimed in claim 20, wherein the predetermined condition requires the graphical representation to be selected and the application to receive an instruction to replace the graphical representation from an apparatus external to the apparatus executing the application.

25. The apparatus as claimed in claim 20, wherein the apparatus is operable to:
after executing the application, request for contents of the one or more graphical representations to be displayed on the home screen from an apparatus external to the apparatus executing the application.

26. The apparatus as claimed in claim 20, wherein the one or more graphical representations comprises an icon and a banner or video that is selectable by a user to perform the one or more actions.

27. The apparatus as claimed in claim 20, wherein the one or more graphical representations comprises a wallpaper that displays one or more other graphical representations in it, and the wallpaper is activatable to enable at least one of the one or more other graphical representations in it to be selected to perform the one or more actions.

28. The apparatus as claimed in claim 20, wherein one of the one or more graphical representations displays one or more other graphical representations in it, and at least one of the one or more other graphical representations is selectable to perform the one or more actions.

29. The apparatus as claimed in claim 20, wherein one of the one or more graphical representations is configured to display a virtual place controllable by a user to move within the virtual place and to display one or more other graphical representations located at different locations in the virtual place.

30. The apparatus as claimed in claim 20, wherein the one or more actions after selecting one of the one or more graphical representations comprises one or more of the following:
opening one or more web pages; and
downloading one or more files, or one or more applications.

31. The apparatus as claimed in claim 20, wherein the apparatus is operable to:
provide a search function to enable searching of one or more graphical representations that is displayable on the home screen.

32. The apparatus as claimed in claim 31, wherein the apparatus is operable to:
replace the one or more graphical representations discoverable by the search function.

33. The apparatus as claimed in claim 20, wherein the one or more actions after selecting one of the one or more graphical representations comprises activating one or more applications, wherein the one or more activated applications comprises an emulator configured to execute an application not natively executable by an operating system of the apparatus.

34. The apparatus as claimed in claim 33, wherein the emulator is configured to facilitate downloading and installation of an application executable by the emulator, and the apparatus is operable to instruct the emulator to install and execute the application after the application is installed, wherein the selected graphical representation is configured to advertise the downloaded and installed application.

35. The apparatus as claimed in claim 34, wherein the one or more activated applications further comprises an application store application configured to facilitate downloading of an application executable by the emulator, and the apparatus is operable to:
instruct the emulator to install and execute the downloaded application,
wherein the selected graphical representation is configured to advertise the downloaded and installed application.

36. The apparatus as claimed in claim 33, wherein the application executed to display the one or more graphical representations is configured to check whether the emulator is installed and to install the emulator if the emulator is not installed.

37. The apparatus as claimed in claim 20, wherein the application executed to display the one or more graphical representations is an emulator configured to execute an application not natively executable by an operating system of the apparatus, and the emulator is configured to download, install and execute an application executable by the emulator when one of the one or more graphical representations advertising the downloaded and installed application is selected.

38. The apparatus as claimed in claim 20, wherein the one or more graphical representations are categorised, and the apparatus is operable to:
display only one graphical representation per category on the home screen.

39. A non-transitory machine-readable medium storing an application to be executed by a processor during start up of an apparatus to operate the apparatus to:
display on a display one or more graphical representations on a home screen of the apparatus without preventing accessibility to at least one feature of the home screen that is not displayed by the application in the home screen; and
replace the one or more graphical representations displayed on the home screen,
wherein each of the one or more displayed graphical representations is replaced when a predetermined condition is satisfied,
wherein at least one of the one or more graphical representations is an advertisement selectable by a user to perform one or more actions.
